(19) United States
(12) Patent Application Publication
(10) Pub. No.: US 2020/0311760 A1
(43) Pub. Date: Oct. 1, 2020

(54) Anonymous App-less digital Punch cards based loyalty programs

(71) Applicant: Narayanan Lakshmanan, Loma Linda, CA (US)

(72) Inventor: Geetha Narayanan, Loma Linda, CA (US)

(21) Appl. No.: 16/836,908

(22) Filed: Mar. 31, 2020

Related U.S. Application Data
(60) Provisional application No. 62/827,179, filed on Mar. 31, 2019.

(51) Int. Cl. G06Q 30/02

(52) U.S. Cl. CPC G06Q 30/0236; G06Q 30/0239; G06Q 30/0229

(57) ABSTRACT

Digital Punch cards based loyalty program, promotions and customer retention solution in an app-less, download-free, installation-free, account-free anonymous way to consolidate all participating merchants customer Digital Punch cards rewards, loyalty cards, vouchers and gift cards from multiple vendors in a single place by providing a solution that requires no downloading, no installation of an application in mobile devices, requires no account creation, no credit cards, requires no personal information such as email number or phone number or first name or last name or address and allows customers to remain anonymous. The program is not anonymous, completely managed and controlled by the vendor and punches are issued by the vendor.

### CROSS-REFERENCE TO RELATED APPLICATIONS

This application claims the benefit of U.S. Provisional Application No. 62/827,179 filed Mar. 31, 2019, all of which are hereby incorporated by reference.

### BACKGROUND OF THE INVENTION

Customer retention programs such Punch cards, rewards cards, loyalty cards, Vouchers and gift cards etc., require either an application to be downloaded or a physical card or paper card or registration/login or tied to their credit card. There are customers who do not want to perform one or more of the above for every program and have one for every small business (Like cafe, carwash, saloon, yoga studio, Gym, mom and pop restaurants, etc). Customers cannot consolidate all the digital punch cards in one place without an identifiable account. As far as small to mid-size businesses are concerned, they do not have a technical team or the capital to create, maintain and track them digitally for this use case. There is also no anonymous punch card based consolidated centralized system.

### BRIEF SUMMARY OF THE INVENTION

The present solution seeks to provide an app-less, download-free, installation-free, account-free way to consolidate all participating merchants customer Loyalty DIGITAL punch cards, Vouchers and gift cards from multiple vendors in a single place by providing an internet application that requires no downloading, no installation of an application in mobile devices, requires no account creation, requires no credit card, requires no personal information such as email number or phone number or first name or last name or address and allows customers to remain anonymous. The customer also do not need any scanning capabilities to use it.

### BRIEF DESCRIPTION OF DRAWINGS

FIG. 1 is a sequence diagram of Issuing initial Digital Punch for an Anonymous user in Multi-Tenant merchant system. This illustrates the sequence in a common Multi-Tenant Loyalty website.

FIG. 1A is a sequence diagram of Issuing initial Digital Punch for Anonymous user in Multi-Tenant merchant system. This illustrates the sequence from an individual merchant's website.

FIG. 2 is a sequence diagram of Issuing additional Digital Punch during subsequent visits by an Anonymous user in Multi-Tenant merchant system. This illustrates the sequence from a common Multi-Tenant Loyalty website.

FIG. 2A is a sequence diagram of Issuing additional Digital Punch during subsequent visits by an Anonymous user in the Multi-Tenant merchant system. This illustrates the sequence from an individual merchant's website

FIG. 3 is a sequence diagram of redeeming Digital Punch during subsequent visits by an Anonymous user in a Multi-Tenant merchant system or Merchant's website.

FIG. 4 Block diagram of the System Architecture.

FIG. 5 Flow diagram of Anonymous user getting Digital Punch from Merchant using centralized website.

FIG. 6 Block flow diagram depicting a method to Anonymous account into registered account conversion.

FIG. 7 Block flow diagram depicting a method to issue promotions for Anonymous user/user, in accordance with certain exemplary embodiments.

FIG. 8 Block flow diagram depicting a method to issue punch cards based Subscription to goods for Anonymous users and registered users.

FIG. 9 Block flow diagram depicting a method to automatically get punches in digital punch card for online order.

FIG. 10 Block flow diagram depicting a method to predict successful punch cards models based on usage. Punches prediction engine for designing punch card models.

FIG. 11 Block flow diagram depicting a method 11000 to refer a friend to get punches in a digital punch card. Anonymous users can refer to other Anonymous users.

FIG. 12 Merchant View. Digital Punch card Loyalty system would allow merchants to see all their customers' punches.

FIG. 13 Customer View. Digital Punch card Loyalty system would allow users both registered and anonymous to see all their punches across merchants.

### DETAILED DESCRIPTION OF THE INVENTION

The present invention provides a unique approach to solve and increase the usage of digital punch cards based loyalty programs. The main challenges faced by current programs is the user participation to the loyalty programs require an application (Mobile app) to be downloaded or a physical card or paper card or registration/login with Personally identifiable information (PII) or tied to their credit card. The end customers do not like to perform one or more of the above for every program and have one for every small business (Like cafe, carwash, saloon, yoga studio, Gym, mom and pop restaurants, etc).

WebSocket is a computer communications protocol, providing full-duplex communication channels over a single TCP connection. The WebSocket protocol was standardized by the IETF as RFC 6455 in 2011, and the WebSocket API in Web IDL is being standardized by the W3C.

The USER'S DEVICE can be smartphone or tablet or a laptop or the smart watch.

MERCHANT DEVICE/SYSTEM can be mobile phone or pos system or pos terminal and QR code scanner or a tablet.

MULTI-TENANT-SYSTEM. It is a shared environment, where many merchant's share the same system resources and database resources, but each merchant's data is isolated and remains invisible to other merchants.

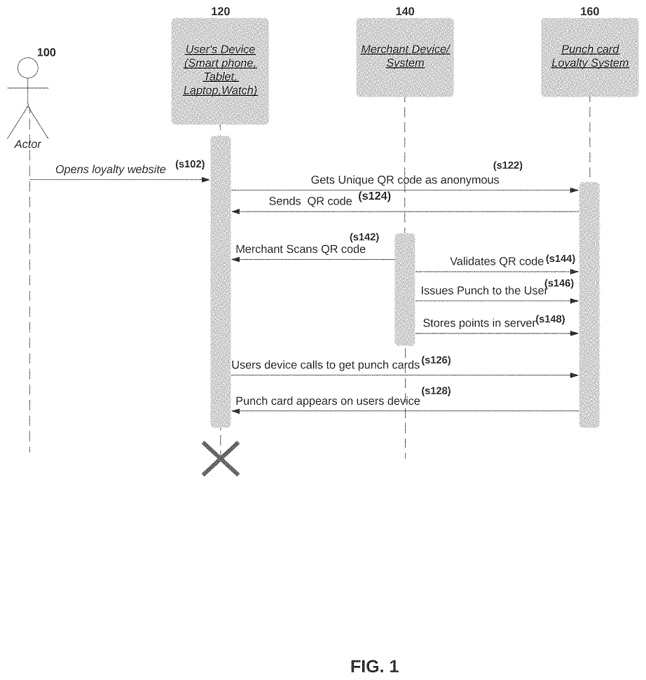

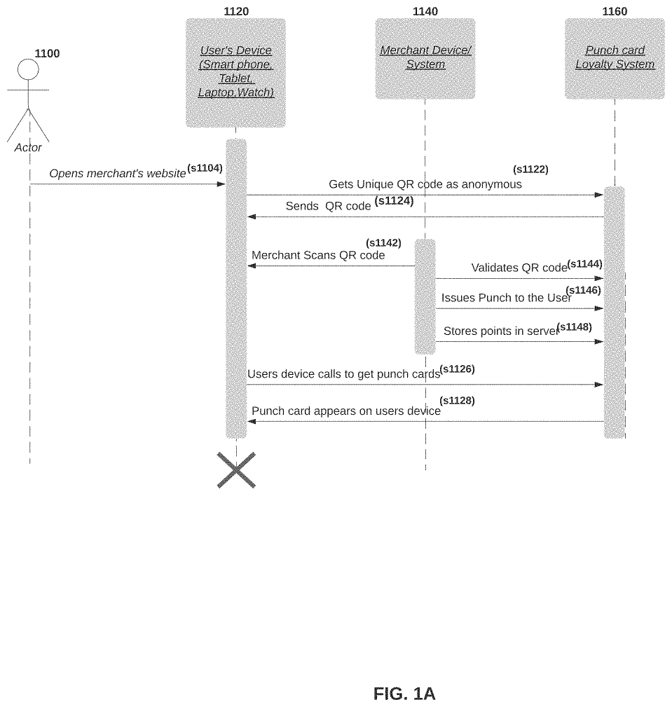

FIG. 1—is a sequence diagram of Issuing initial Digital Punch for an Anonymous user in a Multi-Tenant merchant system. This illustrates the sequence in a common Multi-Tenant Loyalty website.

When the user 100, who want to participate in digital punch card based Loyalty program, opens Multi-Tenant Loyalty common website (s102) on the user device 120. The user device 120 can be smartphone or tablet or a laptop or a smart watch. When Multi merchant website loads on the user device 120, it request a QR code (s122). When a QR code request is made, an account is created as anonymous user in the Punch card Loyalty system 160. The system 160 then returns the QR code (s124) associated with the anonymous account to the user device 120. At this step, the Anonymous user was created and QR code is loaded and stored on the users device 120. The only action performed by the user is open the app-less shared website.

Participating Merchant then can scan the QR code of the Users device 120 from the Merchant device/System 140 (s142). Merchant device/System 140 can be mobile phone or pos system or pos terminal and QR code scanner or a tablet. Once the Merchant scans the QR code, the QR code is validated in the Punch card Loyalty system 160 for validity(s144). The merchant is presented with all the punch card offers that are on the Merchant device/System 140, the merchant then issues one or more punches (s146) based on the offer. Those punches were stored in the Punch card Loyalty system 160 for persistence. (s148)

The user 100 from the users device 120 refreshes to get the update, during the update process, the users device 120 call the Punch card Loyalty system 160 to get newly issued digital punch cards (s126). The Punch card Loyalty system 160 returns the digital punch cards to the user device 120 and punch cards with newly issued punches appear (s128).

FIG. 1A is a sequence diagram of Issuing initial Digital Punch for Anonymous users in a Multi-Tenant merchant system. This illustrates the sequence in an individual merchant's website.

When the user 1100, who wants to participate in digital punch card based Loyalty program, opens app-less merchant website (s1104) on the user device 1120. The user device 1120 can be a smart phone, tablet, laptop, or a smart watch. When the merchant website loads on the user device 1120, it requests a QR code (s1122). When a QR code request is made, an account is created as an anonymous user in the Punch card Loyalty system 1160. The system 1160 then returns the QR code (s1124) associated with the anonymous account to the user device 1120. At this step, the Anonymous user was created and QR code is loaded and stored on the users device 1120. The only action performed by the user is to open the merchant's website.

Participating Merchant then can scan the QR code of the Users device 1120 from the Merchant device/System 1140 (s1142). Merchant device/System 140 can be mobile phone or pos system or pos terminal and QR code scanner or a tablet. Once the Merchant scans the QR code, the QR code is validated in the Punch card Loyalty system 1160 for validity (s1144). The merchant is presented with all the punch card offers that are on the Merchant device/System 1140, the merchant then issues one or more punches (s1146) based on the offer. Those punches were stored in the Punch card Loyalty system 1160 for persistence. (s1148)

The user 1100 from users device 1120 refreshes to get the update, during the update process, the users device 1120 call the Punch card Loyalty system 1160 to get newly issued digital punch cards (s1126). The Punch card Loyalty system 1160 returns the digital punch cards to the user device 1120 and punch cards with newly issued punches appear (s1128).

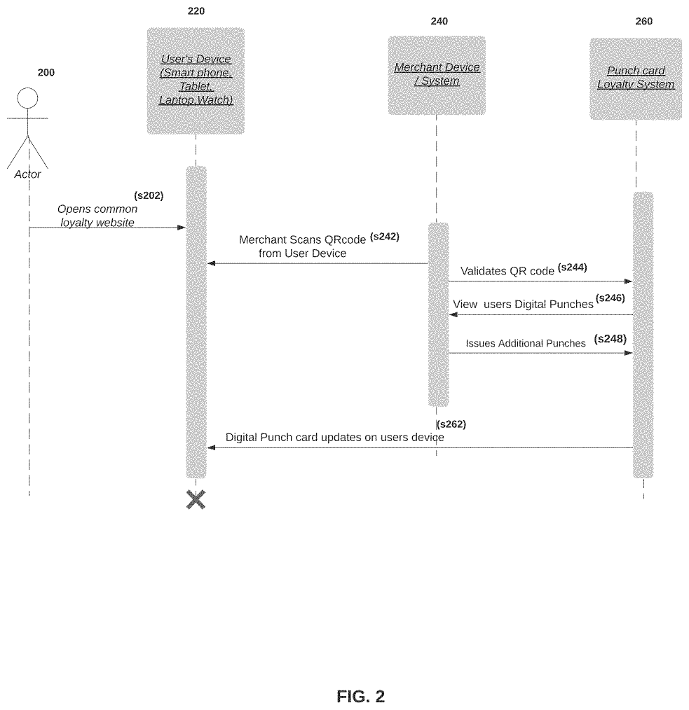

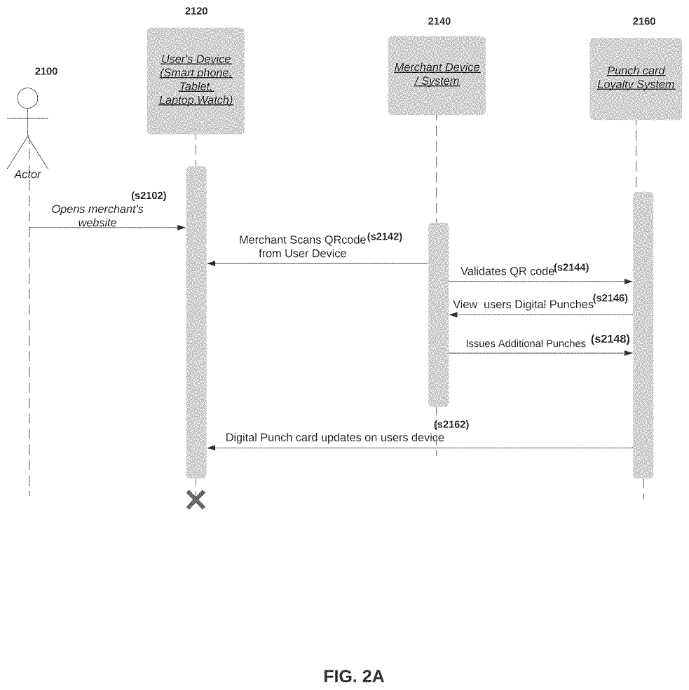

FIG. 2 is a sequence diagram of Issuing additional Digital Punch during subsequent visits by an Anonymous user in the Multi-Tenant merchant system. This illustrates the sequence from a common Multi-Tenant Loyalty website.

When the user 200, during subsequent visit, opens app-less Multi-Tenant Loyalty website (s202) on the user device 220. When the website loads on the user device 220, it loads the QR code from the user device storage. The only action performed by the user is to open the app-less common Multi-Tenant Loyalty website.

Participating Merchant then can scan the QR code of the Users device 220 from the Merchant device/System 240 (s242). Once the Merchant scans the QR code, the QR code is validated in the Punch card Loyalty system 260 for validity (s244). The merchant is presented with all the punch card offers that are on the Merchant device/System 240, the merchant then issues one or more punches (s246). Those punches were stored in the Punch card Loyalty system 260 for persistence. (s248)

The Punch card Loyalty system 260 sends the digital punch cards to the user device 220. The punch cards with newly issued additional punches appear on the user device 220 (s262). The communication used between users device (220) and Punch card Loyalty system 260 is WebSocket protocol.

Another aspect is an user through users device 220, can manually refresh and call the Punch card Loyalty system 260 to get newly issued additional punches.

FIG. 2.A is a sequence diagram of Issuing additional Digital Punch during subsequent visits by an Anonymous user in the Multi-Tenant merchant system. This illustrates the sequence from an individual merchant's website.

When the user 2100, during subsequent visit, opens app-less Multi-Tenant Loyalty website (s2102) on the user device 2120. When the website loads on the user device 2120, it loads the QR code from the user device storage. The only action performed by the user is to open the app-less individual merchant's website.

Participating Merchant then can scan the QR code of the Users device 2120 from the Merchant device/System 2140 (s2142). Once the Merchant scans the QR code, the QR code is validated in the Punch card Loyalty system 2160 for validity (s2144). The merchant is presented with all the punch card offers that are on the Merchant device/System 2140, the merchant then issues one or more punches (s2146). Those punches were stored in the Punch card Loyalty system 2160 for persistence. (s2148)

The Punch card Loyalty system 2160 sends the digital punch cards to the user device 2120. The punch cards with newly issued additional punches appear on the user device 2120 (s2162). The communication used between users device (2100) and Punch card Loyalty system 2160 is WebSocket protocol.

Another aspect is user 2100 through users device 2120, can manually refresh and call the Punch card Loyalty system 2160 to get newly issued additional punches.

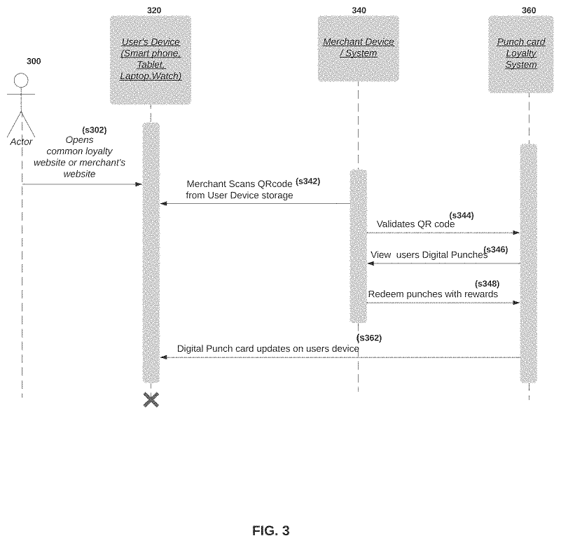

FIG. 3 is a sequence diagram of redeeming Digital Punch during subsequent visits by an Anonymous user in a Multi-Tenant merchant system or Merchant's website.

When the user 300, during subsequent visit, opens app-less Multi-Tenant Loyalty website or Merchant's website (s302) on the user device 320. When the website loads on the user device 320, it loads the QR code from the user device storage. The only action performed by the user is to open the app-less common Multi-Tenant Loyalty website or Merchant's website.

Participating Merchant then can scan the QR code of the Users device 320 from the Merchant device/System 340 (s342). Once the Merchant scans the QR code, the QR code is validated in the Punch card Loyalty system 360 for validity (s344). The merchant sees all the punch cards of the user on the Merchant device/System 340 (s346), the merchant then redeems punches with rewards. Those punches were stored in the Punch card Loyalty system 260 for persistence. (s248)

The Punch card Loyalty system 360 sends the updated digital punch cards to the user device 320 (s262). The communication used between users device (320) and Punch card Loyalty system 260 is WebSocket protocol.

Another aspect is that users through device 320, can manually refresh and call the Punch card Loyalty system 360 to get the latest punch cards.

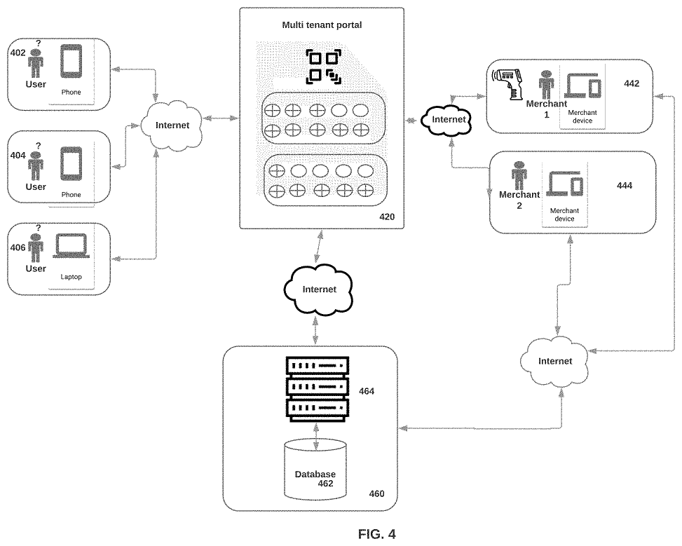

FIG. 4. Block diagram of the System Architecture.

Turning now to FIG. 4, this interaction diagram reflects how the technology and human interactions intersect. The users reflected in FIGS. 402, 404 and 406 go to the multi tenant portal reflected by FIG. 420 to request their QR code. The multi tenant portal (420) calls the API server reflected in FIG. 464 to authenticate to the Database reflected in FIG. 462. The API server (464) either retrieves or creates a QR for the user and returns it to the multi tenant portal (420) which is shown on the user devices (406, 404, 402).

The merchant(s) who is reflected in FIGS. 442,444) logs into the multi-tenant portal and scans the user's (402, 404, 406) QR code using a scanning device (442) or the phone's camera (444). Once scanned, the multi-tenant portal makes a request to the API server (464) to the Database (462) to retrieve the user's existing punch cards. The API server (464) either returns punch cards to the multi tenant portal or indicates that none exist which shows up on the merchant devices reflected in FIGS. 444, 442).

The merchant reviews the punch cards in the multi tenant portal (420) and issues punch, the multi tenant portal (420) calls the API server (464) to update the Database (462). The API Server (464) returns success to the multi-tenant portal (420) and refreshes the user browsers in the devices reflected in FIGS. 402, 404 and 406). The punch is successfully issued to the device.

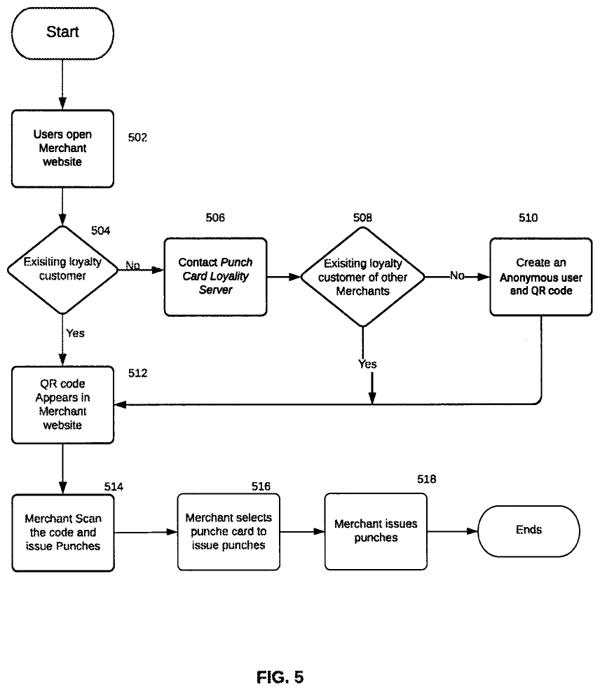

FIG. 5 Flow diagram of Anonymous user getting Digital Punch from Merchant using centralized website.

Users reflected in (502) will go to the merchant's website and the website will determine if they are an existing user (504) by performing subsequent actions. The subsequent actions will include the website contacting the Loyalty server (506) and if they are an existing user (508), they will see their QR code (512) with existing punch cards. If they are not an existing user (506), a new QR code will be created (510) and the user will see the QR code on the merchant website (512). Once the QR code is shown to the merchant, the merchant (514) will scan the QR code and the merchant will select the punch card for which the punch will be applied (516) and the merchant will issue the punch (518).

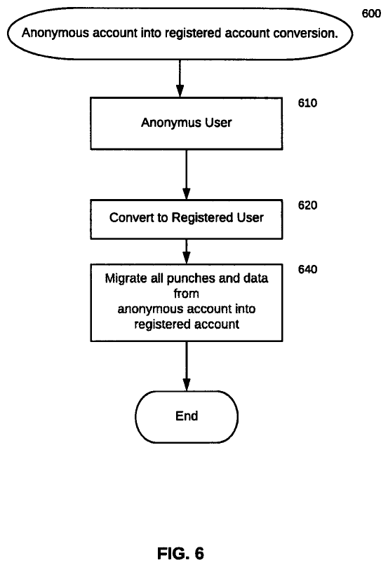

FIG. 6 is a Block flow diagram depicting a method to Anonymous account into registered account conversion.

User opens the Multi-Tenant Loyalty/Merchant website on the user device.

User device opens as anonymous account user (610). All the users punches on digital punch cards, digital promotion punch cards and digital subscription punch cards appear. Users convert anonymous accounts into registered accounts (620). All punches on digital punch card, digital promotion punch card, history of usage, and subscription digital punch card move from anonymous account into registered account (630).

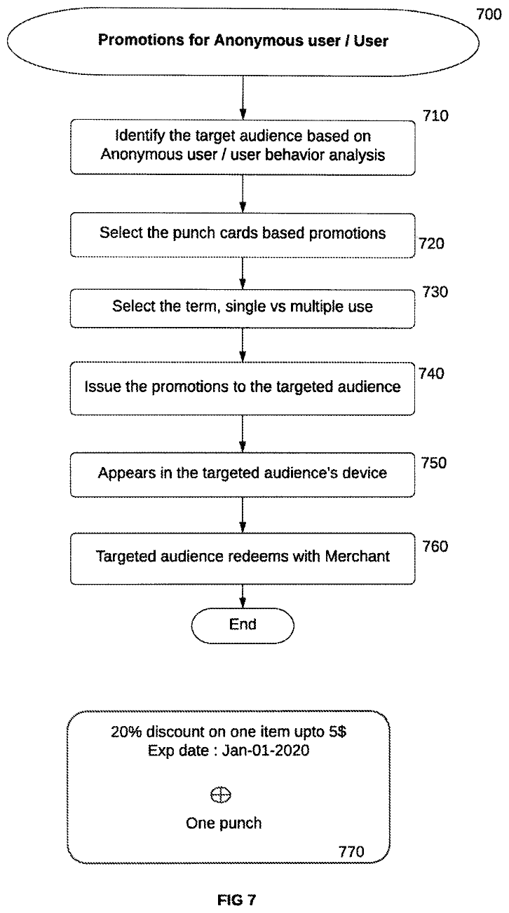

FIG. 7 is a block flow diagram depicting a method 700 to issue promotions for Anonymous user/user, in accordance with certain exemplary embodiments.

To issue promotion to users, In block 710 the merchant identifies the target audience based on Anonymous user/user behavior analysis. Target audience includes both anonymous users and registered users. After the target audience is selected, in the block 720 the merchant selects the punch cards based promotion that the user would like to offer. Merchants can also select the promotion term, single vs multiple use for the selected promotion is shown in Block 730. single means promotion can be used only one time. Multiple use means promotion can be used multiple times. Merchant Issues the promotions to the targeted audience showed in block 740. In Block 750, the Merchant Issued promotion appears in the targeted audience device. In Block 760 describes Targeted audiences can redeem the promotions that were issued.

The uniqueness of the solution is Anonymous user behavior analysis related to the punch card to create new promotions.

770 shows an example promotion with “20% discount on one item up to 5$ Exp date: Jan-01-2020” The promotion expires on Jan-01-2020. The user gets a 20% discount up to $5.

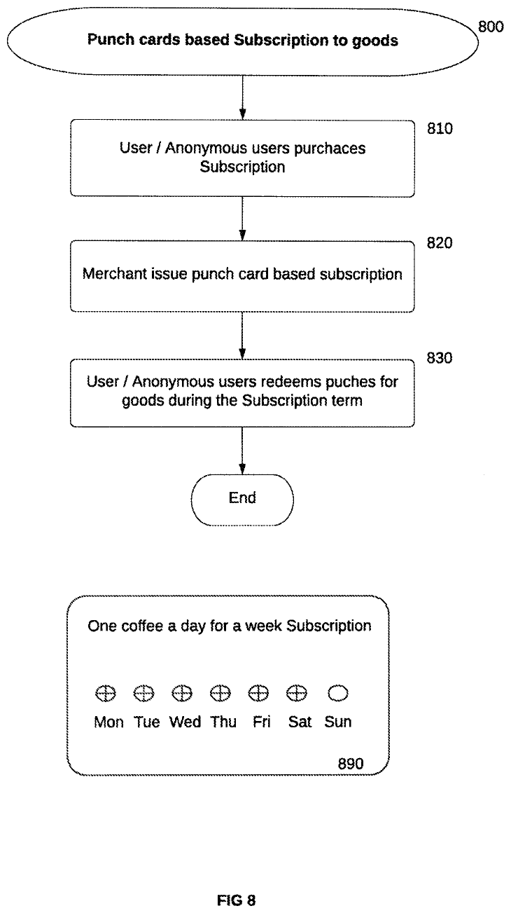

FIG. 8 is a block flow diagram depicting a method 800 to issue punch cards based Subscription to goods for Anonymous users and registered users.

In block 810, User/Anonymous users buy Subscriptions to goods. E.g Subscriptions are One coffee a day for a week, One coffee a day for a month, Two latte subscriptions per day. In block 820, once the user purchased the subscription either in store or through online, merchants issue appropriate punch cards to the anonymous or registered users.

In block 830, anonymous users redeem punches with the merchant for goods during the Subscription term.

890 shows an example punch card for “One coffee a day for a week Subscription”

The uniqueness of this approach is, an anonymous user can subscribe to Subscription to goods and Subscription is based on punch cards.

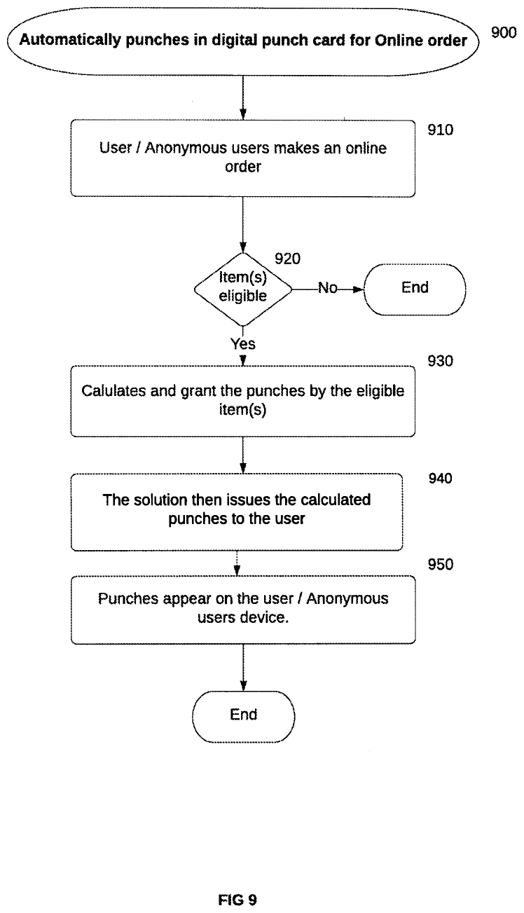

FIG. 9 is a block flow diagram depicting a method 900 to automatically get punches in a digital punch card for online order.

In block 910, User/Anonymous users make an online order in the merchant store or multi-tenant store. Once the order is completed, the solution checks if the purchased items are eligible for punches in block 920. If purchased items are punches eligible, the solution calculates how many punches that can be issued in block 930. e.g 1, Purchasing one coffee on Tuesday gets two punches e.g 2, Purchasing one coffee gets one punch on Mondays. e.g 3, Only one punch per order even if the user purchased 5 coffee. e.g 4, Zero (0) punches for Burritos purchase. in Block 940, the solution then issues the calculated punches to the user who purchased online. On the user's device, punches appear on the users punch cards (Block 950).

The uniqueness of this approach is, an anonymous user can not only order online, but also get punches in a punch card based loyalty program.

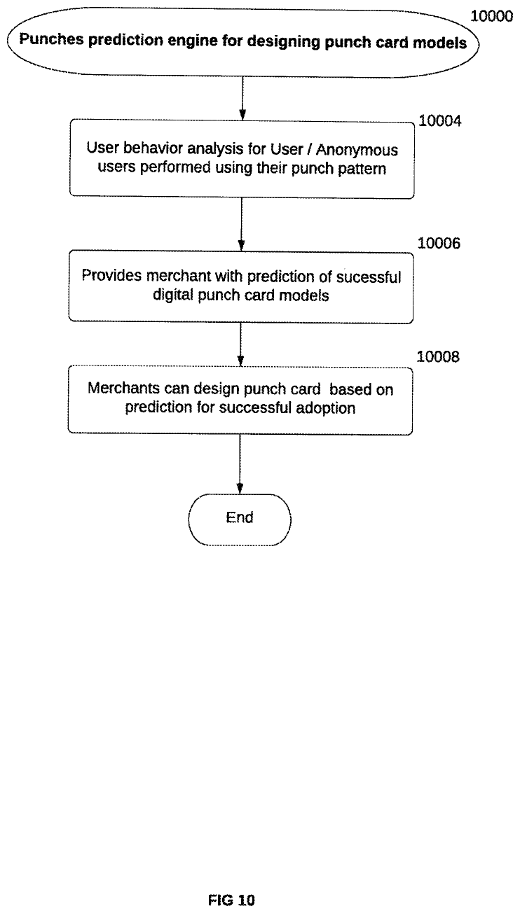

FIG. 10 is a block flow diagram depicting a method 10000 to predict successful punch cards models based on usage. Punches prediction engine for designing punch card models.

In the block 10004, user behavior analysis will be done on Anonymous users/registered users and their punch pattern, timing of when punches were issued, merchant types. In the block 10006, Analysis is completed on a daily basis and the successful punch card models will be offered to the merchants. Merchants can design punch cards based on prediction for successful adoption as illustrated in the block 10008. Once the punch card models were created, the merchant can then provide those to the users and anonymous users.

The uniqueness of this approach is analyzing the punch card usage by anonymous users along with registered users to create new punch card models.

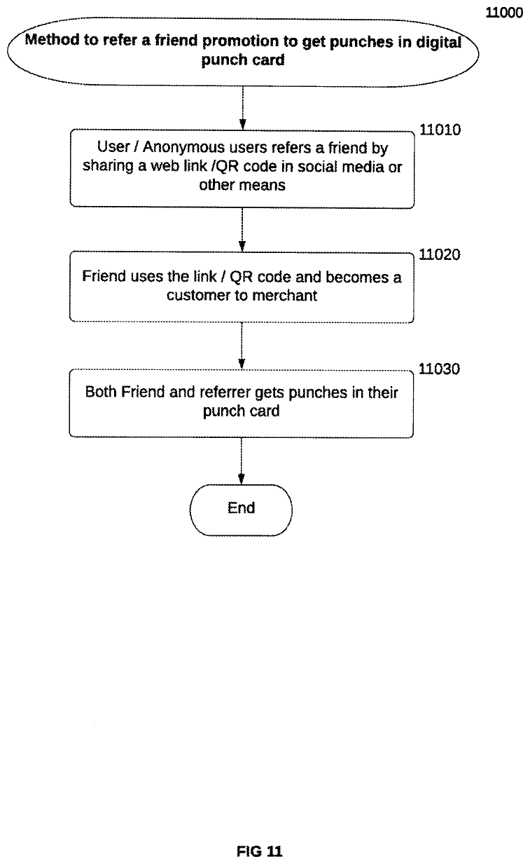

FIG. 11 is a block flow diagram depicting a method 11000 to refer a friend to get punches in a digital punch card.

Block 11010 depict user/anonymous users can refers a friend promotion by sharing a web link/QR code in social media or other means. Once the friend receives, Block 11020 depict friend uses the link/QR code and becomes a user/anonymous users/customer to merchant. Block 11030 depicts both friend and the referrer get punches in their punch card.

The uniqueness of this approach is that an anonymous user can refer to another anonymous user and both can automatically receive punches in their punch card based promotion.

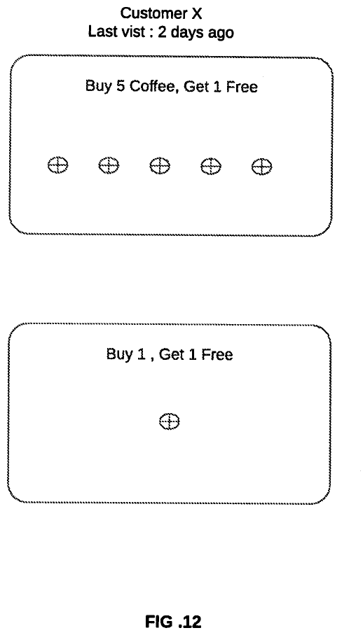

FIG. 12 is Merchant View. Digital Punch card Loyalty system would allow merchants to see all their customers' punches.

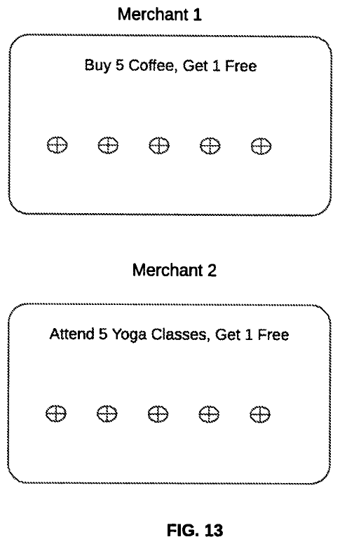

FIG. 13 is Customer View. Digital Punch card Loyalty system would allow users both registered and anonymous to see all their punches across merchants.

I claim as my invention:

1) A method for offering loyalty program for anonymous members using digital punch cards that requires no downloading, no installation of an application in mobile devices, requires no account creation, requires no credit card, requires no personal information, the method comprising:
A) Open a common Multi-Tenant Loyalty website on the user device. The user device can be smartphone or tablet or laptop or smart watch.
B) Multi Tenant Loyalty website loads on the user device.
C) On loading, the user device loads the QR code information related to the Anonymous account from local storage of the users device.
D) When QR code information related to an Anonymous account from local storage is not found during the first visit, the user device requests a new Anonymous account from Punch card Loyalty server.
E) Punch card Loyalty server creates a new Anonymous account and sends a QR code related to Anonymous account to the users devices on the response.
F) QR code information related to Anonymous accounts is stored in local storage of user device.
G) QR code appears on the user device.
H) Merchant through his Merchant device then can scan the QR code of the Users device.
I) Merchant device/System is presented with all the punch cards offers of the Merchant from Punch card Loyalty server.
J) Merchant issues one or more punches on the device.
K) User refreshes his device and sees the new digital punch card and with the new punches.

2) The method of claim 1, wherein the step (A) comprises the user opens the participating merchants website instead of Multi-Tenant Loyalty website from users device.

3) The method of claim 1, wherein the step (I) comprises, the redeem rewards of digital punch cards.
Merchant device/System is presented with all the digital punch cards of the user related to the Merchant from Punch card Loyalty server.
Based on the offer, Merchant redeems digital punch cards on the Merchant device.
User refreshes his device and sees the updated digital punch cards.

4) The method of claim 1, wherein the step (I) comprises, the redeem rewards through digital subscription punch cards.
Merchant device/System is presented with all the punch cards of the user including the digital subscription punch cards of the Merchant from Punch card Loyalty server.
Based on the offer, Merchant issues one or more punches on the digital subscription punch cards on the Merchant device.
User refreshes his device and sees the updated digital subscription punch cards.

5) The method of claim 1, wherein the step (I) comprises the users device redeem promotions through digital promotions punch cards.
Merchant device/System is presented with all the punch cards of the user including the digital promotions punch cards of the Merchant from Punch card Loyalty server.
Based on the offer ,Merchant redeems digital promotions punch cards on the Merchant device.
User refreshes his device and sees the updated digital promotions punch cards.

6) The method of claim 1, wherein the user can be a registered account user instead of an anonymous account user.

7) The method of claim 1, wherein digital punch cards can use points instead of punches.

8) A method for digital punch cards based loyalty program anonymous users to order online and get punches in punch cards that requires no downloading, no installation of an application in mobile devices, requires no account creation. The method comprising.
A) Anonymous users make an online order in the merchant store or Multi-Tenant website store.
B) Once the order is completed, the solution checks if the purchased items are eligible for punches
C) If purchased items are punches eligible, the system calculates how many punches that can be issued
D) Punch card Loyalty server then issues the calculated punches to the user who purchased by online.
E) On the user's device, punches appear on the punch cards.

9) The method of claim 8, wherein the user can be a registered account user instead of an anonymous account user.

10) The method of claim 8, wherein the step (A) comprises the user opens the participating merchants website instead of Multi-Tenant website from users device.

11) The method of claim 8, wherein the step (B) comprises the user orders by redeeming digital promotions punch cards towards eligible goods.

12) The method of claim 8, wherein the step (B) comprises the user orders by redeeming digital subscription punch cards towards eligible goods.

13) An anonymous digital punch cards loyalty program system, comprising:
Storage and database.
Network
Server with computing
Serverless functions
Website for Multi-Tenant
For users of anonymous digital punch cards loyalty program systems comprising a database with a plurality of participant accounts, each of the participant accounts identified only by the ID associated. The user id is used to create the OR code. All the accounts have their own space in the database where they have access to the data.
For Merchants of anonymous digital punch cards loyalty program system comprising a database with a plurality of participant merchant accounts, each of the participant accounts identified only by the ID associated. The user id is tied to all the data. All the accounts have their own space in the database where they have access to the data.
Digital punch cards loyalty program systems would allow merchants to see all their customers punches.
Digital punch cards loyalty program system would allow users both registered and anonymous to see all their punches across merchants.
Merchants can have many store locations and custom promotions for each store in the database.
Loyalty program system in communication with each of the users using webSocket when a reward is offered.
